(19) United States
(12) Patent Application Publication
(10) Pub. No.: US 2017/0212298 A1
(43) Pub. Date: Jul. 27, 2017

(54) PLASTIC FRAMES, BACKLIGHT MODULES, AND DISPLAY DEVICES

(71) Applicant: Wuhan China Star Optoelectronics Technology Co., Ltd., Wuhan (CN)

(72) Inventors: Qian CHEN, Shenzhen (CN); Zhongjie LIU, Shenzhen (CN)

(73) Assignee: Wuhan China Star Optoelectronics Technology Co., Ltd., Wuhan (CN)

(21) Appl. No.: 15/173,413

(22) Filed: Jun. 3, 2016

(30) Foreign Application Priority Data
Jan. 26, 2016 (CN) 201610050757.0

(51) Int. Cl. F21V 8/00

(52) U.S. Cl. CPC G02B 6/0088; G02B 6/0051; G02B 6/0053; G02F 1/133528

(57) ABSTRACT

A plastic frame is configured for fixing a backlight module generating a light source and for transmitting the light source to a panel. The plastic frame includes end surfaces for adhering adhesive-shading tape. The end surface is configured with an elastic protrusive portion. With such configuration, when the liquid crystal panel is pressed, the elastic protrusive portion operates as a buffer to absorb the shocks. In this way, the top and the down prism sheets, a diffuser sheet, or a light guiding plate are prevented from being crushed or scraped. In addition, a backlight module and a display device are also disclosed.

### FIELD OF THE INVENTION

The present invention relates to an electronic display device technology, and more particularly to a plastic frame, a backlight module and a display device.

### BACKGROUND OF THE INVENTION

Generally, a backlight module is configured for supplying backlit to the display module within a display device. With the increasing demand toward high-resolution, the demand toward high brightness has also been increased. Thus, high brightness processes have to be applied to components within the backlight module, which generally needs glue with high intensity or the glue without coating on the surface. This may reduce the anti-scrape or other performance of the films after the high brightness process is applied. When users touch or press the display panel to conduct the reliability test, the display panel may sink down to the top/down prisms. As such, the top/down prisms may crush the diffuser sheet and the light guiding plate, and the performance and the reliability of the display device may be reduced.

### SUMMARY OF THE INVENTION

The present disclosure relates to a plastic frame, a backlight module, and a display device, wherein the top and down prism sheets, a diffuser sheet, or a light guiding plate are prevented from being crushed or scraped when the liquid crystal panel is pressed.

In one aspect, a plastic frame for fixing a backlight module generating a light source and for transmitting the light source to a panel includes: wherein two pairs of sidewalls are configured and one of the sidewall within one pair is opposite to the other sidewall within the same pair, the sidewalls are connected end to end, each of the sidewalls includes a top end surface, a down end surface, and two lateral surfaces connecting the top end surface and the down end surface; and an elastic protrusive portion is arranged on the top end surface of the sidewall.

Wherein a cross-section of the elastic protrusive portion is arch-shaped.

Wherein a cross-section of the elastic protrusive portion is rectangular-shaped.

Wherein the elastic protrusive portion is made by elastic PC material.

Wherein the plastic frame and the elastic protrusive portion are made by double-injection.

In another aspect, a backlight module includes: a lamp set, a light guiding plate, a diffuser sheet, a down prism sheet, a top prism sheet, and the above plastic frame, the lamp set is configured for emitting light beams toward the light guiding plate, the top prism sheet, the down prism sheet, the diffuser sheet, and the light guiding plate are stacked in sequence, and the diffuser sheet is fixed on the plastic frame via adhesive glue adhered to the elastic protrusive portion.

Wherein the light guiding plate includes a light emitting surface, a back surface opposite to the light emitting surface, and a lateral surface connecting the light emitting surface and the back surface, the lamp set is arranged in a rim of the lateral surface of the light guiding plate to emit light beams toward the light guiding plate, the diffuser sheet includes a first end and a second end opposite to the first end, and the first end is close to the lamp set, and the first end of the diffuser sheet is fixed on the plastic frame via the adhesive glue adhered to the elastic protrusive portion.

Wherein a cross-section of the elastic protrusive portion is arch-shaped.

Wherein a cross-section of the elastic protrusive portion is rectangular-shaped.

In another aspect, a display device includes: a liquid crystal panel and the above backlight module, the liquid crystal panel includes a top polarizer, a color filter, a thin film transistor, and a down polarizer, a down surface of the down polarizer contacts with the elastic protrusive portion, and the down surface of the down polarizer is fixed on the backlight module via the adhesive glue adhered to the elastic protrusive portion.

In view of the above, the elastic protrusive portion is arranged on the end surface of the adhesive-shading tape of the plastic frame. When the liquid crystal panel is pressed, the elastic protrusive portion operates as a buffer to absorb the shocks. That is, although the press impulse remains the same, the application time is increased such that the pressing force toward the liquid crystal panel is decreased. In this way, the films may be prevented from being crushed or scraped.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a side view of one end of the plastic frame of the display device close to a lamp set in accordance with one embodiment.

FIG. 2 is a side view of one end of the plastic frame of the display device far away from the lamp set in accordance with one embodiment.

FIG. 3 is a front view of the plastic frame of the display device in accordance with one embodiment.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

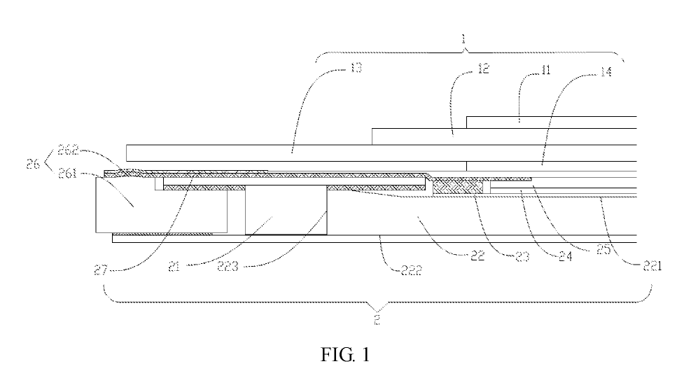

As shown in FIGS. 1, 2 and 3, the display device includes a liquid crystal panel 1 and a backlight module 2. The liquid crystal panel 1 includes a top polarizer 11, a color filter (CF) 12, a thin film transistor (TFT) 13, and a down polarizer 14. The backlight module 2 includes a lamp set 21, a light guiding plate 22, a diffuser sheet 23, a down prism sheet 24, a top prism sheet 25, and a plastic frame 26. The top prism sheet 25, the down prism sheet 24, the diffuser sheet 23 and the light guiding plate 22 are stacked in sequence. The light guiding plate 22 includes a light emitting surface 221, a back surface 222 opposite to the light emitting surface 221, and a lateral surface 223 connecting the light emitting surface 221 and the back surface 222. The lamp set 21 is arranged in a rim of the lateral surface 223 of the light guiding plate 22 to emit light beams toward the light guiding plate 22. The diffuser sheet 23 includes a first end and a second end opposite to the first end, and the first end is close to the lamp set 21.

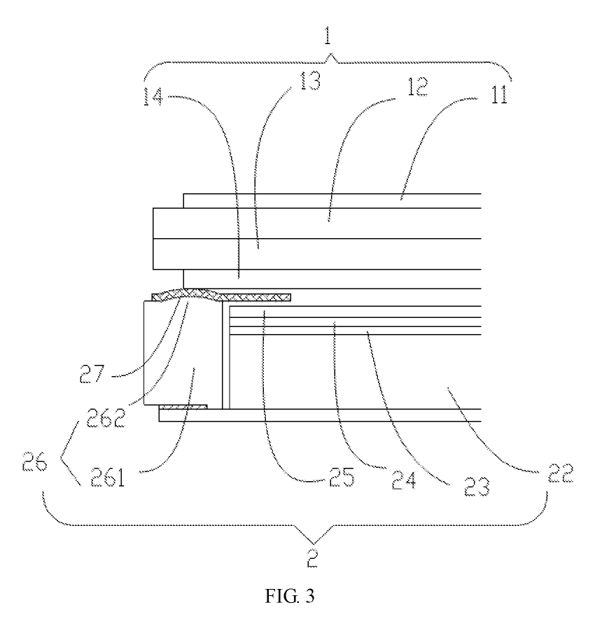

It is to be noted that the structure of display device is symmetric along a left-right direction. FIG. 3 only shows one end of the display device, and the structure of the other end may also reference to FIG. 3.

The plastic frame 26 is configured for fixing the backlight module 2 generating a light source and transmitting the light source to the panel. The plastic frame 26 includes four sidewalls 261, wherein two pairs of sidewalls are configured and one of the sidewall within one pair is opposite to the other sidewall within the same pair, and the sidewalls 261 are connected end to end. Each of the sidewalls 261 includes a top end surface, a down end surface, and two lateral surfaces connecting the top end surface and the down end surface. An elastic protrusive portion 262 is arranged on the top end surface of the sidewall 261.

In the embodiment, the plastic frame is made by elastic material, which may be extended or bent freely. The elastic protrusive portion 262 may be made by elastic PC material. PC material relates to amorphous thermoplastic resin with excellent overall performance. Such material is characterized by attributes, such as good electrical insulation, extensibility, dimensional stability, chemical resistance, higher intensity, thermal resistance, and cold resistance. The plastic frame 26 and the elastic protrusive portion 262 are made by double-injection to integrally form the plastic frame and the protrusion portion made by different materials. The cross section of the elastic protrusive portion 262 may be arch-shaped or rectangular-shaped. It can be understood that the cross section of elastic protrusive portion 262 may be of other shapes.

Referring to FIG. 1, the diffuser sheet 23 is fixed on the plastic frame via adhesive glue 27, such as air-gap, adhered on the elastic protrusive portion 262. The elastic protrusive portion 262 may increase paste area of the adhesive glue so as to firmly fix the films on the plastic frame.

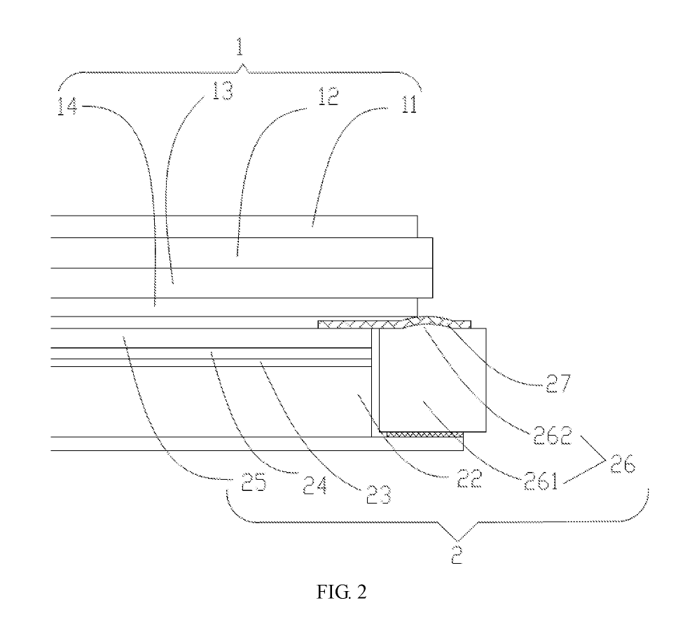

Referring to FIGS. 2 and 3, a down surface of the down polarizer 14 contacts with the elastic protrusive portion 262, and the down surface of the down polarizer 14 is fixed on the backlight module 2 via the adhesive glue adhered to the elastic protrusive portion 262. When the user touches or presses the liquid crystal panel 1 to conduct reliability test, the elastic protrusive portion 262 operates as a buffer to absorb the shocks. That is, although the press impulse remains the same, the application time is increased such that the pressing force toward the liquid crystal panel 1 is decreased. In this way, the films may be prevented from being crushed or scraped.

In the embodiment, the plastic frame may be applicable to the edge-lit backlight module or direct-lit backlight module.

Above are embodiments of the present invention, which does not limit the scope of the present invention. Any modifications, equivalent replacements or improvements within the spirit and principles of the embodiment described above should be covered by the protected scope of the invention.

What is claimed is:

1. A plastic frame for fixing a backlight module generating a light source and for transmitting the light source to a panel, comprising:
wherein two pairs of sidewalls are configured and one of the sidewall within one pair is opposite to the other sidewall within the same pair, the sidewalls are connected end to end, each of the sidewalls comprises a top end surface, a down end surface, and two lateral surfaces connecting the top end surface and the down end surface; and
an elastic protrusive portion is arranged on the top end surface of the sidewall.

2. The plastic frame claimed in claim 1, wherein a cross-section of the elastic protrusive portion is arch-shaped.

3. The plastic frame claimed in claim 1, wherein a cross-section of the elastic protrusive portion is rectangular-shaped.

4. The plastic frame claimed in claim 2, wherein the elastic protrusive portion is made by elastic PC material.

5. The plastic frame claimed in claim 4, wherein the plastic frame and the elastic protrusive portion are made by double-injection.

6. A backlight module, comprising:
a lamp set, a light guiding plate, a diffuser sheet, a down prism sheet, a top prism sheet, and a plastic frame having two pairs of sidewalls and an elastic protrusive portion, wherein one of the sidewall within one pair is opposite to the other sidewall within the same pair, the sidewalls are connected end to end, each of the sidewalls comprises a top end surface, a down end surface, and two lateral surfaces connecting the top end surface and the down end surface, and the elastic protrusive portion is arranged on the top end surface of the sidewall; and
the lamp set is configured for emitting light beams toward the light guiding plate, the top prism sheet, the down prism sheet, the diffuser sheet, and the light guiding plate are stacked in sequence, and the diffuser sheet is fixed on the plastic frame via adhesive glue adhered to the elastic protrusive portion.

7. The backlight module claimed in claim 6, wherein the light guiding plate comprises a light emitting surface, a back surface opposite to the light emitting surface, and a lateral surface connecting the light emitting surface and the back surface, the lamp set is arranged in a rim of the lateral surface of the light guiding plate to emit light beams toward the light guiding plate, the diffuser sheet comprises a first end and a second end opposite to the first end, and the first end is close to the lamp set, and the first end of the diffuser sheet is fixed on the plastic frame via the adhesive glue adhered to the elastic protrusive portion.

8. The backlight module claimed in claim 7, wherein a cross-section of the elastic protrusive portion is arch-shaped.

9. The backlight module claimed in claim 7, wherein a cross-section of the elastic protrusive portion is rectangular-shaped.

10. A display device, comprising:
a liquid crystal panel and a backlight module, the backlight module comprising:
a lamp set, a light guiding plate, a diffuser sheet, a down prism sheet, a top prism sheet, and a plastic frame having two pairs of sidewalls and an elastic protrusive portion, wherein one of the sidewall within one pair is opposite to the other sidewall within the same pair, the sidewalls are connected end to end, each of the sidewalls comprises a top end surface, a down end surface, and two lateral surfaces connecting the top end surface and the down end surface, and the elastic protrusive portion is arranged on the top end surface of the sidewall;
the lamp set is configured for emitting light beams toward the light guiding plate, the top prism sheet, the down prism sheet, the diffuser sheet, and the light guiding plate are stacked in sequence, and the diffuser sheet is fixed on the plastic frame via adhesive glue adhered to the elastic protrusive portion; and
the liquid crystal panel comprises a top polarizer, a color filter, a thin film transistor, and a down polarizer, a down surface of the down polarizer contacts with the elastic protrusive portion, and the down surface of the down polarizer is fixed on the backlight module via the adhesive glue adhered to the elastic protrusive portion.
